(19) United States
(12) Patent Application Publication
(10) Pub. No.: US 2002/0052871 A1
(43) Pub. Date: May 2, 2002

(54) Chinese natural language query system and method

(75) Inventors: Feng Lin Chang, Taipei (TW); Ching-Long Yeh, Taipei (TW)

Correspondence Address: BACON & THOMAS, 4th Floor, 625 Slaters Lane, Alexandria, VA, 22314, US

(73) Assignee: SimpleAct Incorporated, Taipei (TW)

(21) Appl. No.: 09/880,806

(22) Filed: Jun. 15, 2001

(30) Foreign Application Priority Data
Nov. 2, 2000 (TW) 089123053

(51) Int. Cl. G06F 7/00

(52) U.S. Cl. 707/3

(57) ABSTRACT

The system consists of the following modules: natural language processing module, document database module, document metadata module, matching module and answer extraction module. The natural language processing module gets user's input Chinese query sentence and processes the sentence to obtain the corresponding deep syntactic structure. The document database module consists of a repository to store the documents about the knowledge of the application domains. The document metadata module is used to create the metadata for the entries stored in the document database. The matching module is used to compare the deep syntactic structure of the input query sentence with the metadata stored in the metadata module to obtain meaning-equivalent entries. The answer extraction module then extracts, according to the indices of the meaning-equivalent entries, the documents from the document database as the output for the user's request.

### DESCRIPTION

This patent is concerned with a natural language query system and method that enables user to enter Chinese sentence as the query request.

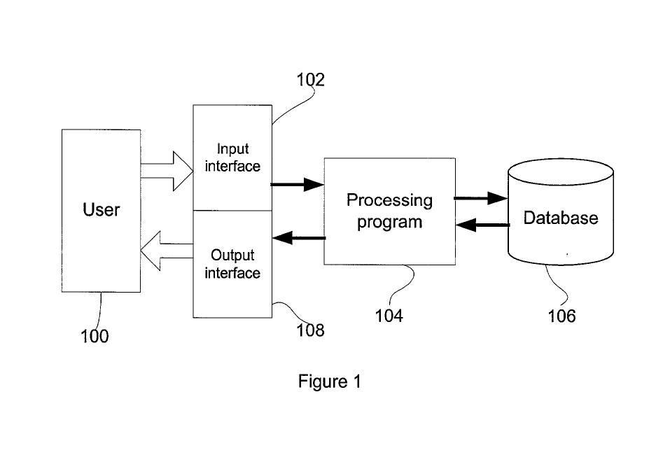

As shown in FIG. 1 is the block diagram of a typical query system of former approach. When user (100) wants to query an object such as a book or magazine, he or she enters keywords about the target through a user interface (102). The processing program (104) finds out the relevant entries from the database (106), and then presents the result to user (100) on the output interface (108).

The approach described, however, above has the following drawbacks.

1. User can only input limited keywords as the query criterion.

2. User cannot enter sentence to express appropriately the meaning of the query request.

To solve the above problems, we propose a natural language query system. The natural language query system consists of the following modules: natural language processing module, document database module, document metadata module, matching module and answer extraction module. Each of the modules is described as follows.

The natural language processing module takes user's Chinese query sentence as the input, and processes the sentence to obtain the corresponding deep syntactic structure.

The document database module consists of a repository that is used to store the documents about the knowledge of the application domains.

The document metadata module is used to create and store the metadata for the entries stored in the document database. Each document in the document database has a corresponding metadata that describes the meaning of the document content.

The matching module compares the deep syntactic structure produced by the natural language processing module with the metadata stored in the metadata database in order to find out meaning-equivalent entries.

The answer extraction module then extracts, according to the indices of the meaning-equivalent entries, the document from the document database as the output for the user's request.

In addition to the above modules, the system consists of an Input/output interface and knowledge bases for the natural language processing module and matching module.

The input interface provides a means for user to enter query sentences either by typing characters or voice. The output interface is used to present to user the solution produced by the answer extraction module. The knowledge base for natural language processing module contains the knowledge necessary for processing input sentences, which includes a lexicon, lexical rules, syntax rules and semantic interpretation rules. The knowledge base for the matching module contains rules for determining the equivalence of two deep syntactic structures.

In this patent, we propose a method for natural language query. User enters a Chinese sentence through keyboard or voice input as the query condition. The system returns user with answers corresponding to the input sentence.

The processing steps of the natural language query method are described as follows. First, the input sentence is processed to obtain the deep syntactic structure of the sentence. Then the obtained deep syntactic structure is compared with the entries in the metadata module. Then an index of matched entry in the metadata module is used to retrieve the document in the document database. Finally, the document is presented to user.

In this patent we propose a natural language processing component that enables user to enter Chinese query sentence by keyboard or voice. This component contains a natural language processing program that analyzes the input sentence to obtain the corresponding deep syntactic structure. A knowledge base provides the necessary knowledge for the natural language processing program. The natural language processing program consists of a word segmentation program, a parsing program and a semantic interpretation program.

The word segmentation program takes the query sentence as the input and produces a word sequence. The parsing program then takes the word sequence as the input and produces the structure of the sentence. The semantic interpretation program does the task of semantic interpretation by taking the structure of the sentence as the input and produces the corresponding deep syntactic structure.

By using the “deep syntactic structure” stated in this patent, we can easily develop the matching program and the task of semantic interpretation can be simplified. For understanding of the features and advantages of this patent, we illustrate in the following with examples and diagrams.

### BRIEF DESCRIPTIONS OF THE DIAGRAMS

FIG. 1 is a diagram of former approach.

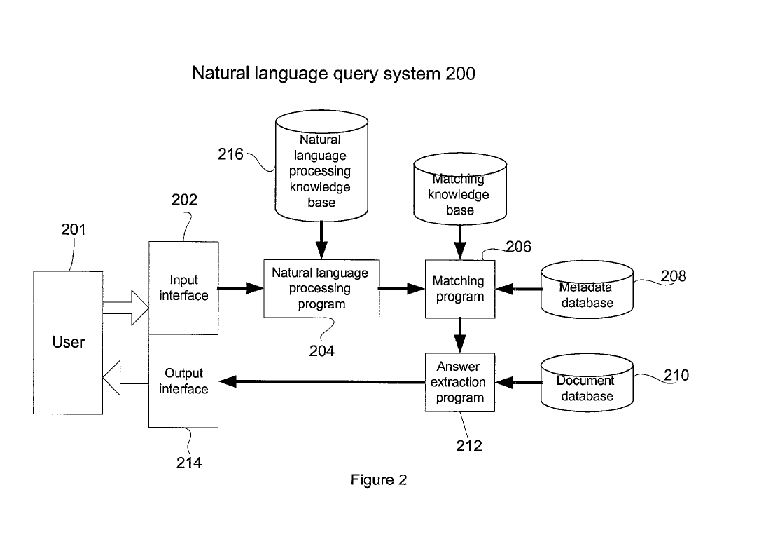

FIG. 2 is a diagram of this patent.

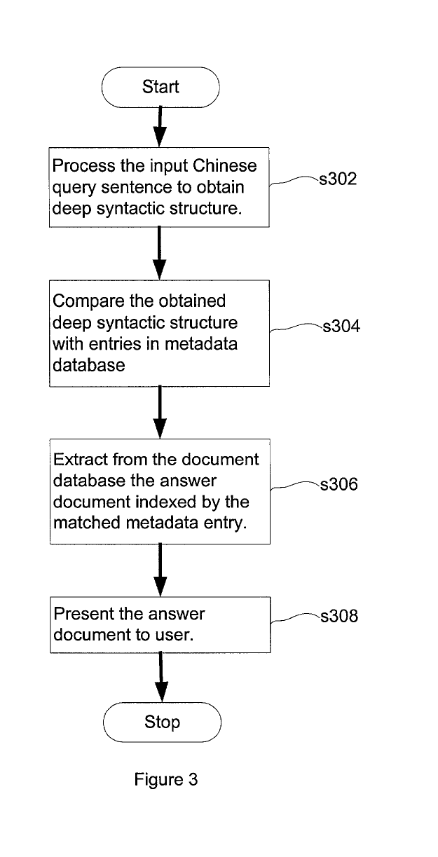

FIG. 3 is a flow chart of this patent.

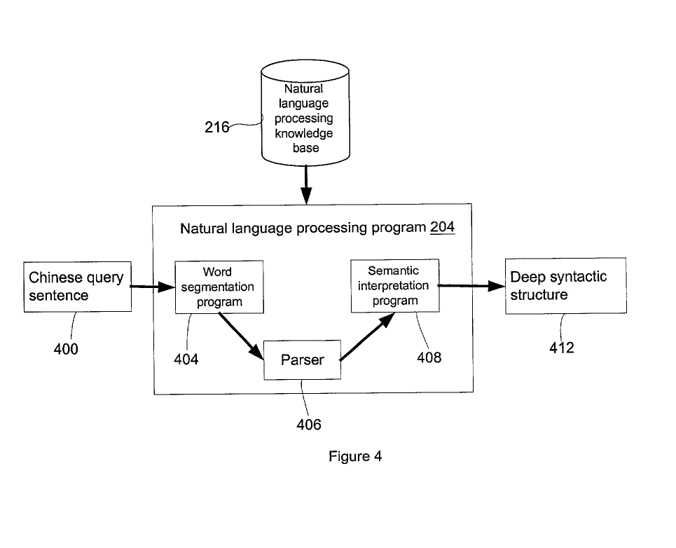

FIG. 4 is a diagram of this patent.

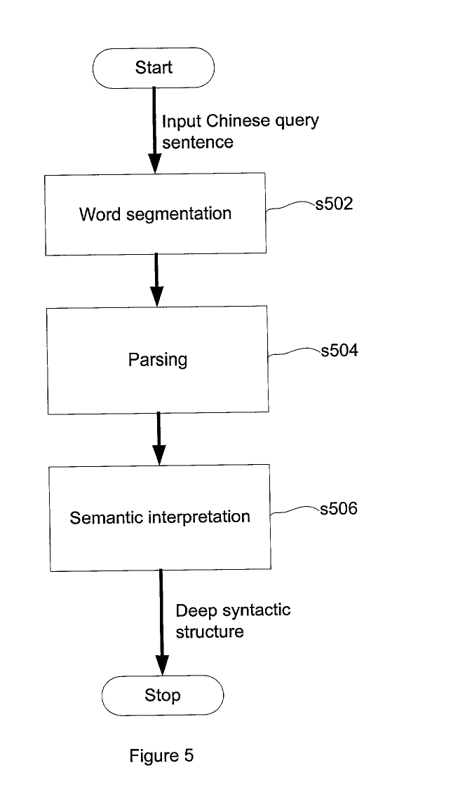

FIG. 5 is a flow chart of this patent.

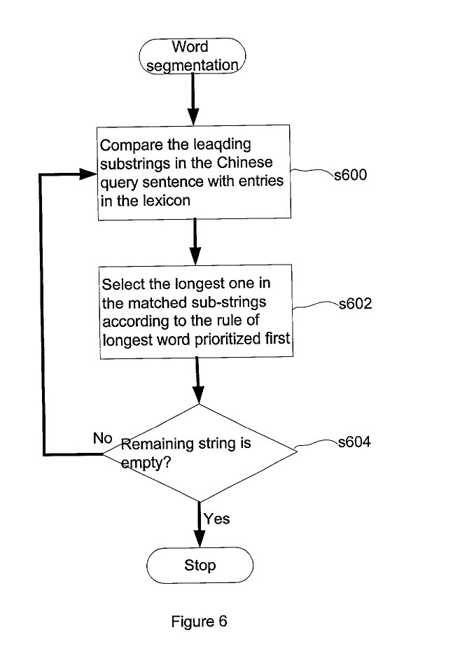

FIG. 6 is a flow chart of this patent.

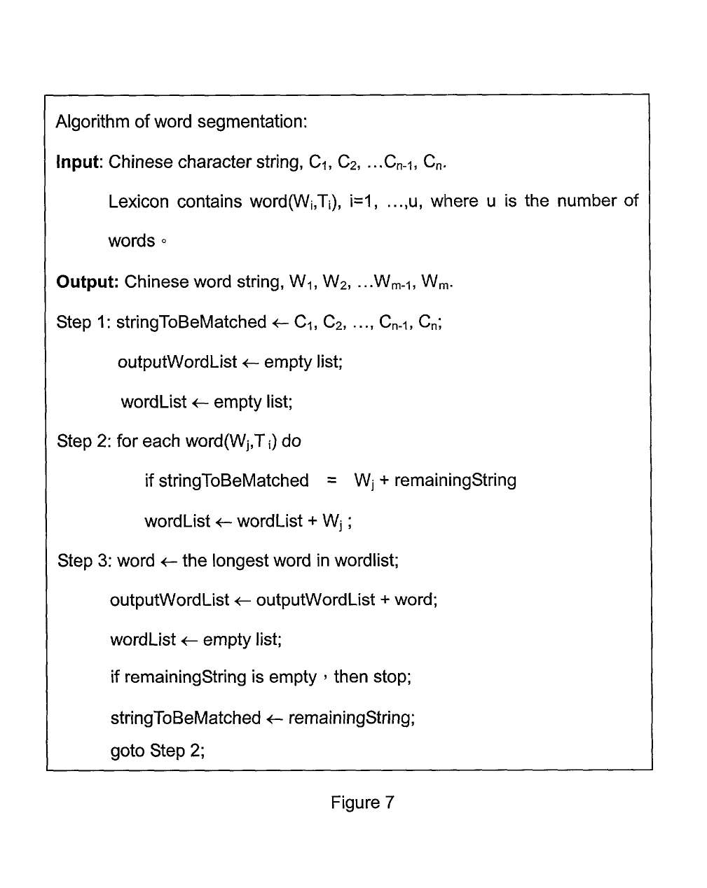

FIG. 7 is a diagram of this patent.

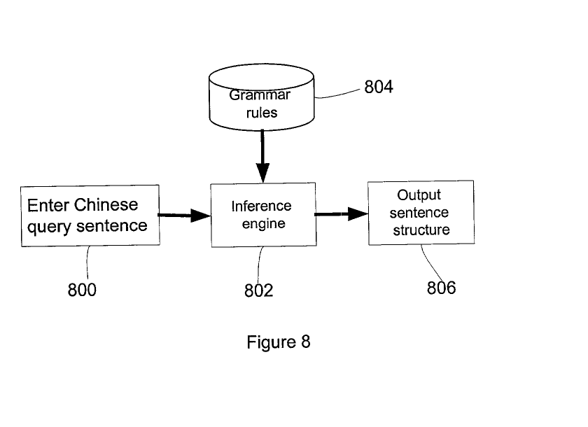

FIG. 8 is a diagram of this patent.

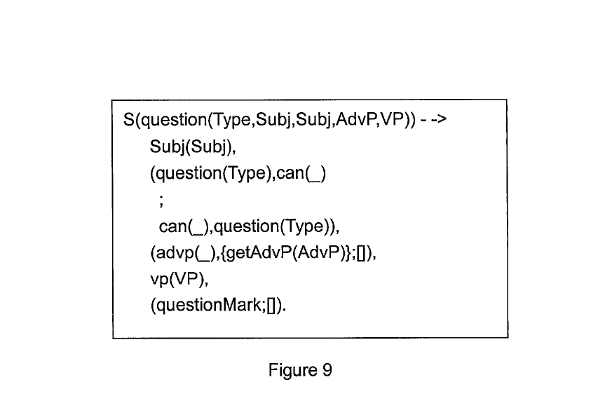

FIG. 9 is a diagram of this patent.

Indices of components

100,201: user

102, 202: input interface

104: processing program

106: database

108, 214: output interface

200: natural language query system

204: natural language processing program

206: matching program

208: metadata database

210: document database

212: answer extraction program

216: natural language processing knowledge base

218: matching knowledge

400: Chinese query sentence

404: word segmentation program

406: parsing program

408: semantic interpretation program

412: deep syntactic structure

500: input sentence

502: inference engine

504: grammar rules

506: output sentence structure

Steps s302 to s308 are an example of this patent, and steps s502 to s604 are another example.

An Example Showing the Advantage of Using our Method:

As shown in FIG. 2 is an example of using the natural language query system proposed in this patent. User enters a Chinese query sentence by using voice input or keyboard. After processing the input query sentence, user obtains the information about the query sentence. The natural language query system consists of the following components: a natural language processing program (204), a document database (210), a metadata database (208), an answer extraction program (212) and a matching program (206). Among the components, the natural language processing program (204) is used to process the Chinese input sentence entered by user (201). It produces the corresponding deep syntactic structure of the input query sentence. The document database (210) is used to store the document about the knowledge of application domain. For example, if the application domain is about a financial department, then the document database (210) contains the document about the knowledge of financial issues.

The metadata database (208) that is associated with the document database (210) is used to describe the content of document about domain knowledge. The entries in the metadata (208) are represented in deep syntactic structures. The matching program (206) compares the deep syntactic structure produced by the natural language program (204) with the entries in the metadata database (208) to obtain meaning-equivalent one. The answer extraction program (212) then retrieves the documents from the document database (208) according to the indices of the meaning-equivalent entry just obtained. Furthermore, this natural language query system (200) includes an input interface (202), an output interface (214), a natural language processing knowledge base (216) and a matching knowledge base (216).

The input interface (202) that is the front end of the natural language processing program (204) is used by user (201) to input Chinese query sentence. The output interface (214) that is the backend of the answer extraction program (212) presents the matched document for user (201) to read. The natural language processing knowledge base (206) provides the necessary information for the natural language processing program (204). The information includes lexicon, grammar rules and semantic interpretation rules. The natural language processing program (204) employs the above information to do the tasks of word segmentation, parsing and semantic interpretation. The matching program (206) uses rules in the matching knowledge base (218) to determine the equivalence of two deep syntactic structures.

In the following, we give an example to illustrate the above method. User (201) enters, for example, a Chinese query sentence ¢ [symbol] ” by using the input interface (202). After being processed by the natural language processing program (204), the resulting deep syntactic structure becomes [topic: [symbol] , domain: [symbol] , type: [symbol] , range: [symbol] . The matching program (206) then takes this structure as the input and compares with the entries in the metadata database (208) to obtain the equivalent one. The answer extraction program (212) extracts from the document database (210) the document indexed by the matched entry just obtained and presents to user (201) through the output interface (214).

As shown in FIG. 3 is another example illustrating the advantage of using the natural language processing method proposed in this patent. User enters a Chinese query sentence by using voice input. After being processed by using this method, user obtains the answer corresponding to the input query sentence. The natural language processing method consists of the following steps. Step s302 is to process the input Chinese query sentence and obtain the deep syntactic structure of the input sentence. In Step s304, the obtained deep syntactic structure is compared with the entries in the metadata database. In Step s306, the index of the matched entry is used to extract the corresponding answer in the document database. Finally, in Step s308, the extracted answer is presented to user through the output interface.

The entries stored in the metadata database are represented in deep syntactic structure as well.

As shown in FIG. 4 is an example of component diagram using the method proposed in this patent. The natural language processing program (204) takes Chinese query sentence as input (400) and produces the corresponding deep syntactic structure (412). The natural language processing knowledge base (216) provides the necessary knowledge sources, including lexicon, grammar rules and semantic interpretation rules, for the natural language processing program (204)

The natural language processing program (204) consists of the following components: word segmentation program (404), parser (406) and semantic interpretation program (408). By comparing the sub-strings in the input sentence with entries in the lexicon, the word segmentation program (404) divides the input Chinese query sentence into word sequence. The parser (406) analyzes the word sequence produced by the word segmentation program (404) and produces the structure of the sentence. There are various techniques of the implementation of parser. In this patent, we adopt Definite Clause Grammar (DCG) parser. The semantic interpretation program (408) maps the structure produced by the parser (406) into a deep syntactic structure.

As shown in FIG. 5 are the steps of processing input a Chinese query sentence to obtain the deep syntactic structure. First, in Step s502, the input Chinese query sentence is divided into a sequence of words. Then, in Step s504, the parser analyzes the word sequence. In Step s506, the semantic interpretation program maps the analyzed result into the deep syntactic structure.

As shown in FIG. 6 is the procedure of word segmentation. First, in Step s600, the leading sub-strings are compared with the entries in the lexicon. Then, in Step s602, according to the rule of longest word prioritized first, the longest word in the matched sub-strings is selected and the remaining sub-string becomes the string to be matched in the next round of matching. In Step s604, it checks whether the remaining string is empty. If it is empty, then the procedure is finished; otherwise, it goes back to Step s600. The algorithm of word segmentation is shown in FIG. 7.

As shown in FIG. 8 is the procedure of the DCG parser program. The Chinese grammar rules (804) are represented in DCG, a kind of context-free grammar. The Prolog inference engine (802) then analyzes the input Chinese sentence (800) by consulting the grammar rules (804) and produces the sentence structure (806).

As shown in FIG. 9 is an instance of grammar rule and its parsing result represented in DCG. A DCG rule consists of left-hand side (LHS) and right-hand side (RHS) divided by an arrow “-->”. In the figure, the LHD represents a sentence and its resulting structure. The RHS is the components of a sentence, which in order are the subject, followed by an optional auxiliary verb and question adverb alternatives, an adverb phrase, a verb phrase and finally an optional question mark.

The resulting structure is “question (Type, Subj, Subj, AdvP, VP) ”. The first argument, Type, is the type of question adverb. The second and the third arguments are the topic and subject, respectively. The remaining arguments, AdvP and VP, are the adverb phrase and verb phrase. The details of DCG can be found in Prolog textbooks, such as Clocksin and Mellish, Programming in Prolog, 3ed., 1996, Springer-Verlag.

The semantic interpretation program maps the sentence structure into a deep syntactic structure. A deep syntactic structure is a feature structure. A feature structure is an unordered list of attribute-value pairs, where each attribute is an atom and the accompanied value is a atom or another feature structure. Unification is the main operation of feature structure. The unification of two feature structures A and B is the minimal feature covering both A and B. If no such feature structures exist, then the unification operation fails. The deep syntactic structure consists of topic, type, domain, and range.

We show an example to illustrate the procedure of an input Chinese query sentence being processed in order by word segmentation program, parser and semantic interpretation program. Given an input Chinese query sentence, “ [symbol] [symbol] ”, the word segmentatiori program produces the word sequence: [symbol] ”, “ [symbol] ”, “ [symbol] ”, “ [symbol] ”, “ [symbol] ”, “ [symbol] ”. By taking the word sequence as the input, the parser produces the sentence structure “question(“ [symbol] ”, “ [symbol] ”, “ [symbol] ”,null, “ [symbol] ” (de(“ [symbol] ”, “ [symbol] ”)))”. After mapping by the semantic interpretation program, the seep syntactic structure becomes “[type: “ [symbol] ”, topic: “ [symbol] ”, domain: “ [symbol] ”, range: “ [symbol] (de(“ [symbol] ”,“ [symbol] ”)) ]”.

In brief, the advantages of this patent are as follows.

1. We use deep syntactic structure as the semantic representation of input Chinese query sentence and metadata of document. This makes the matching procedure easier and efficient.

2. The use of deep syntactic structure as the semantic representation of input Chinese query sentence simplifies the task of semantic interpretation.

3. Deep syntactic structure can properly express the semantics of double subject sentences in Chinese.

Although the patent has been illustrated by examples shown previously in this document, it, however, is not restricted to the examples. Anyone who is familiar with the method can make various modifications within the concept and scope of this patent. Therefore, the scope protected by this patent should refer to the ones described below.

1) A natural language query system accepts user entering Chinese query sentence either by voice or keyboard and returns user with the information related to the query sentence. The natural language query system consists of the following components:
A natural language processing program. It processes the input Chinese query sentence and produces the corresponding deep syntactic structure.
A document database. It is used to store document of domain knowledge.
A metadata database. It consists of entries represented in deep syntactic structure describe in deep syntactic structures the meaning of documents in the document database.
A matching program. It takes the deep syntactic structure produced by the natural language processing program as input and compares with entries in the metadata database to obtain matched entries.
An answer extraction program. It gets the indices of the matched entries obtained by the matching program and extracts the entries in the document database according to the indices.

2) The natural language query system described in Item (1) further includes the following components:
An input interface: This is the front end the natural language processing program. It is used for user to enter Chinese query sentence.
An output interface: This is the backend of the answer extraction program. It is used to display to user the document extracted from the document database.
A natural language processing knowledge base: This is the knowledge source of the natural language processing program. It provides the knowledge for the natural language processing program to process the input Chinese query sentence.
A matching knowledge base: This is the knowledge source of the matching program. It consists of rules for determining equivalence of two deep syntactic structures.

3) The natural language query system described in Item (2) further includes a lexicon, a grammar rule base and a semantic interpretation rule base.

4) The processing steps of the natural language query system described in Item (2) include word segmentation, parsing, and semantic interpretation.

5) A natural language query method. User enters a Chinese query sentence, either by keyboard or voice input. By using the method to process the input query sentence, user obtains the information related to the query sentence. The steps of the natural language query method are as follows. First, the input query sentence is processed to obtain the deep syntactic structure. Second the deep syntactic structure is compared with the entries in the metadata database. Third the index of the matched entry is used to extract document from the document database. Finally, the extracted document is presented to user.

6) In the natural language query method described in Item (5), the entries in the metadata database are represented in deep syntactic structures.

7) A natural language processing component. User enters a Chinese query sentence, either by keyboard or voice input. The component analyzes the input query sentence to obtain the deep syntactic structure.

8) A natural language processing knowledge base. It provides the information for the natural language processing component as described in Item (7) to process input Chinese query sentence.

9) Lexicon, grammar rules and semantic interpretation rules. These are contained in the natural language processing knowledge base described in Item (8).

10) The natural language processing component described in Item (7) consists of:
A word segmentation program that is used to divide the input Chinese query sentence into word strings,
A parser that is used to analyze the word string produced by the word segmentation program and produce the structure of the sentence, and
A semantic interpretation program that is used to map the sentence structure produced by the parser into deep syntactic structure.

11) The word segmentation program described in Item (10) compares the leading sub-strings in the Chinese query sentence with entries in the lexicon to obtain matched word.

12) The parser described in Item (10) analyzes a word string to obtain the structure of the sentence.

13) The semantic interpretation program described in Item (10) maps the sentence structure produced by the parser into deep syntactic structure.

14) A natural language processing method. User enters a Chinese query sentence, either by keyboard or voice input. By using the method to process the input query sentence, user obtains the deep syntactic structure of the sentence. The process in order is divided into word segmentation, parsing and semantic interpretation steps. First, in the word segmentation step, the input Chinese query sentence is divided into a word string. Second, in the parsing step, the word string is analyzed to obtain the structure of the sentence. Third, in the semantic interpretation step, the sentence is mapped into the deep syntactic structure.

15) The word segmentation step described in Item (14) is described in details as follows. First, the leading sub-strings of the input Chinese query sentence are compared with entries in the lexicon. Second, according to the rule of longest word prioritized first, the longest matched sub-string is selected from the matched sub-strings. Third, check if the remaining string is empty. If it is empty, then the process is finished; otherwise, go to the first step and continue to process the remaining string.
